(19) United States
(12) Patent Application Publication
(10) Pub. No.: US 2025/0273938 A1
(43) Pub. Date: Aug. 28, 2025

(54) MULTI-DIRECTIONAL MONITORING AND CONTROL OF CABLE CONNECTOR(S) TO FACILITATE AUTOMATED CABLING

(71) Applicant: INTERNATIONAL BUSINESS MACHINES CORPORATION, Armonk, NY (US)

(72) Inventors: Joseph SCAGLIONE, Poughkeepsie, NY (US); Ryan ELSASSER, Salt Point, NY (US); Daniel RUIZ, Cold Spring, NY (US); Schulyer MANN, Poughkeepsie, NY (US)

(21) Appl. No.: 18/585,157

(22) Filed: Feb. 23, 2024

(51) Int. Cl. H02G 1/14; H01R 13/58

(52) U.S. Cl. CPC H02G 1/14; H01R 13/58

(57) ABSTRACT

A system is provided which includes a first carriage assembly to support a first cable connector of a cable, and a second carriage assembly to support a second cable connector of the cable. The first carriage assembly and the second carriage assembly move along a guide. Further, the system includes a controller to monitor and adjust position of at least the second carriage assembly to maintain a tension on the cable within a specified range during an automated cabling operation of the system.

### BACKGROUND

One or more aspects relate in general to facilitating system networking, and more particularly, to facilitating automated cabling of one or more components of a system or system network.

Cables and associated cable connectors are devices used to connect and create an operative coupling between different system components. For instance, in system networking, such as computer networking, cables with appropriate cable connectors can be used to interconnect different system components. By way of example, a server network can contain tens or even hundreds, or more, cables that connect between components. Typically, cables have one cable connector at one end, and another cable connector at another end, with the cable connectors being configured for plugging into respective connector receptacles associated with, for instance, one or more components of the system or system network.

Thousands of cable connector configurations are available, including, for instance, for making power connections, data connections, signal communication connections, audio visual applications, etc. Often, cable connectors are differentiated by function, and include in-line cables which have cable connectors permanently attached to the cable, allowing the cable to be plugged into a connector receptacle, such as a chassis or panel connector permanently attached to a system component, such as a server.

### SUMMARY

Certain shortcomings of the prior art are overcome, and additional advantages are provided herein through the provision of a system which includes a first carriage assembly to support a first cable connector of a cable, and a second carriage assembly to support a second cable connector of the cable. The first and second carriage assemblies move along a guide. In addition, the system includes a controller to monitor and adjust the position of at least the second carriage assembly to maintain a tension on the cable within a specified range during an automated cabling operation of the system.

In another aspect, a computer-implemented method is provided which includes controlling, by a controller operatively coupled to a first electromechanical mechanism and a second electromechanical mechanism of an automated cabling system, tension on a cable held by the first electromechanical mechanism and the second electromechanical mechanism within a specified range to facilitate an automated cabling operation. The first electromechanical mechanism holds a first cable connector of the cable, and the second electromechanical mechanism holds a second cable connector of the cable. The controlling includes monitoring position of at least one cable connector of the first and second cable connectors held by the first and second electromechanical mechanisms, respectively, during the automated cabling operation, and adjusting, based on the monitoring of the position of the at least one cable connector, one or more of the first electromechanical mechanism and the second electromechanical mechanism to maintain the tension on the cable within the specified range to facilitate the automated cabling operation of the automated cabling system.

In a further aspect, a computer program product is provided which includes a set of one or more computer-readable storage media, and program instructions, collectively stored in the set of one or more storage media, for causing at least one processor set to perform computer operations. The computer operations include controlling, by a controller operatively coupled to a first electromechanical mechanism and a second electromechanical mechanism of an automated cabling system, tension on a cable held by the first electromechanical mechanism and the second electromechanical mechanism within a specified range to facilitate an automated cabling operation. The first electromechanical mechanism holds a first cable connector of the cable, and the second electromechanical mechanism holds a second cable connector of the cable. The controlling includes monitoring position of at least one cable connector of the first and second cable connectors held by the first and second electromechanical mechanisms, respectively, during the automated cabling operation and adjusting, based on the monitoring of the position of the at least one cable connector, one or more of the first electromechanical mechanism and the second electromechanical mechanism to maintain the tension on the cable within the specified range to facilitate the automated cabling operation of the automated cabling system.

Additional features and advantages are realized through the techniques described herein. Other embodiments and aspects are described in detail herein and are considered part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to include and/or use one or more of the aspects of the present disclosure;

FIG. 2 depicts one embodiment of a computer program product with an automated cabling controller module, in one or more aspects of the present disclosure;

FIG. 3 depicts one embodiment of an automated cabling controller process, in accordance with one or more aspects of the present disclosure;

FIG. 4A depicts one embodiment of a system network in association with which automated cabling operations can be used, in accordance with one or more aspects of present disclosure;

FIG. 4B depicts another embodiment of a system network in association which automated cabling operations can be used, in accordance with one or more aspects of present disclosure;

FIG. 5 depicts one embodiment of a system component with different types of electrical connector receptacles in association with which an automated cabling operation can be used, in accordance with one or more aspects of present disclosure;

FIG. 6A depicts one embodiment of an automated cabling system, in accordance with one or more aspects of present disclosure;

FIG. 6B is an enlarged depiction of a first cable connector on a first carriage assembly of the system of FIG. 6A undergoing scanning to obtain cable-related data for the automated cabling operation, in accordance with one or more aspects of present disclosure;

FIG. 6C is an enlarged depiction of the robotic tool of the automated cabling system of FIG. 6A gripping the first cable connector of the cable, in accordance with one or more aspects of present disclosure;

FIG. 6D depicts one embodiment of the robotic tool moving the first cable connector during the automated cabling operation towards operative contact with a respective connector receptacle of a system component, in accordance with one or more aspects of present disclosure;

FIGS. 6E-6F are enlarged depictions of the second cable connector of the cable on the second carriage assembly, depicting angular rotation of the second cable connector in two degrees of motion as the robotic tool lifts and moves the first cable connector of the cable into operative connection with a system component, in accordance with one or more aspects of present disclosure;

FIG. 6G depicts the robotic tool gripping the second cable connector of the cable for continuing the automated cabling operation after the first cable connector has been operatively connected to the system component, in accordance with one or more aspects of present disclosure;

FIG. 7 is a schematic diagram illustrating operation of an automated cabling system, such as the automated cabling system of FIGS. 6A-6G, in accordance with one or more aspects of present disclosure;

FIGS. 8A-8B depict one embodiment of an automated cabling controller workflow, in accordance with one or more aspects of present disclosure;

FIGS. 9A-9B depict another embodiment of an automated cabling controller workflow, in accordance with one or more aspects of present disclosure;

FIG. 10 partially depicts an alternate embodiment of an automated cabling system, in accordance with one or more aspects of present disclosure;

FIG. 11 is a schematic of a further embodiment of an automated cabling system, in accordance with one or more aspects of present disclosure;

FIG. 12A depicts an alternate embodiment of a carriage assembly and rotatable fixture for an automated cabling system, such as the automated cabling system of FIGS. 6A-6G, in accordance with one or more aspects of present disclosure; and

FIG. 12B depicts a further alternate embodiment of a carriage assembly and rotatable fixture for an automated cabling system, such as the automated cabling system of FIGS. 6A-6G, in accordance with one or more aspects of present disclosure.

### DETAILED DESCRIPTION

Aspects of the present disclosure and certain features, advantages, and details thereof, are explained more fully below with reference to the non-limiting example(s) illustrated in the accompanying drawings. Descriptions of well-known systems, devices, processing techniques, etc., are omitted so as not to unnecessarily obscure the disclosure in detail. It should be understood, however, that the detailed description and the specific example(s), while indicating aspects of the disclosure, are given by way of illustration only, and are not by way of limitation. Various substitutions, modifications, additions, and/or arrangements, within the spirit and/or scope of the underlying inventive concepts will be apparent to those skilled in the art for this disclosure. Note further that reference is made below to the drawings, where the same or similar reference numbers used throughout different figures designate the same or similar components. Also, note that numerous inventive aspects and features are disclosed herein, and unless otherwise inconsistent, each disclosed aspect or feature is combinable with any other disclosed aspect or feature as desired for a particular application of the concepts disclosed.

Note also that illustrative embodiments are described below using specific code, designs, architectures, protocols, layouts, schematics, systems, or tools only as examples, and not by way of limitation. Furthermore, the illustrative embodiments are described in certain instances using particular software, hardware, tools, and/or data processing environments only as example for clarity of description. The illustrative embodiments can be used in conjunction with other comparable or similarly purposed structures, systems, applications, architectures, etc. One or more aspects of an illustrative control embodiment can be implemented in software, hardware, or a combination thereof.

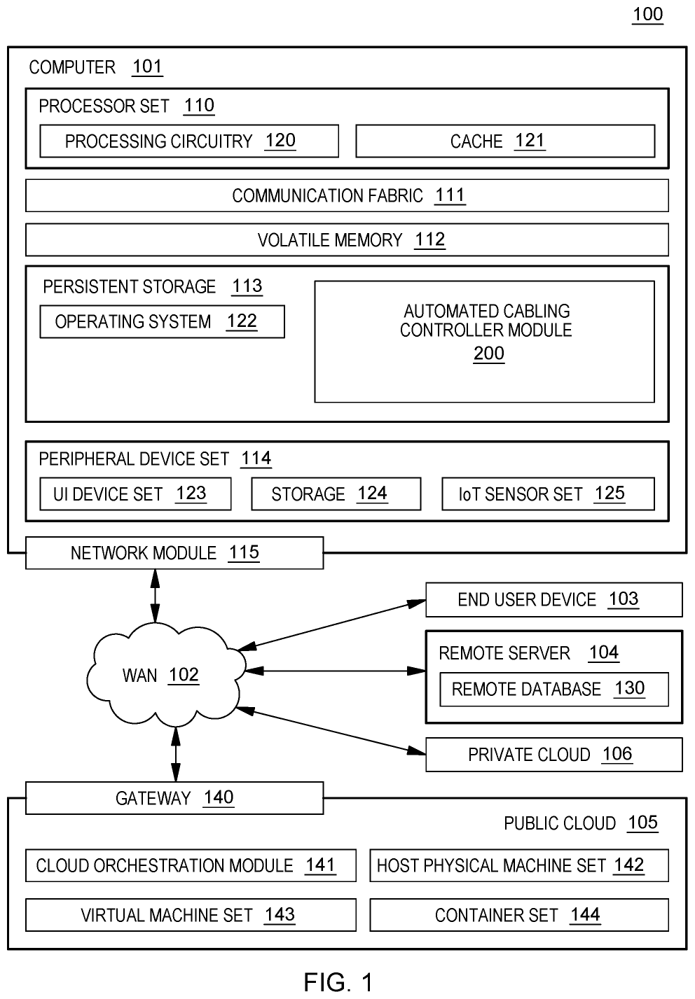

As understood by one skilled in the art, program code, as referred to in this application, can include software and/or hardware. For example, program code in certain embodiments of the present disclosure can utilize a software-based implementation of the functions described, while other embodiments can include fixed function hardware. Certain embodiments combine both types of program code. Examples of program code, also referred to as one or more programs, are depicted in FIG. 1, including operating system 122 and automated cabling controller module 200, which are stored in persistent storage 113.

One or more aspects of the present disclosure are incorporated in, performed and/or used by a computing environment. As examples, the computing environment can be of various architectures and of various types, including, but not limited to: personal computing, client-server, distributed, virtual, emulated, partitioned, non-partitioned, cloud-based, quantum, grid, time-sharing, clustered, peer-to-peer, mobile, having one node or multiple nodes, having one or more processor sets, each with one processor or multiple processors, and/or any other type of environment and/or configuration, etc., that is capable of executing a process (or multiple processes) that, e.g., perform automated cabling controller processing, such as disclosed herein. Aspects of the present disclosure are not limited to a particular architecture or environment.

Prior to further describing detailed embodiments of the present disclosure, an example of a computing environment to include and/or use one or more aspects of the present disclosure is discussed below with reference to FIG. 1.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as automated cabling controller module 200. In addition to module 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and module 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in module 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above is only one example of a computing environment to incorporate, perform and/or use one or more aspects of the present disclosure. Other examples are possible. Further, in one or more embodiments, one or more of the components/modules of FIG. 1 need not be included in the computing environment and/or are not used for one or more aspects of the present disclosure. Further, in one or more embodiments, additional and/or other components/modules can be used. Other variations are possible.

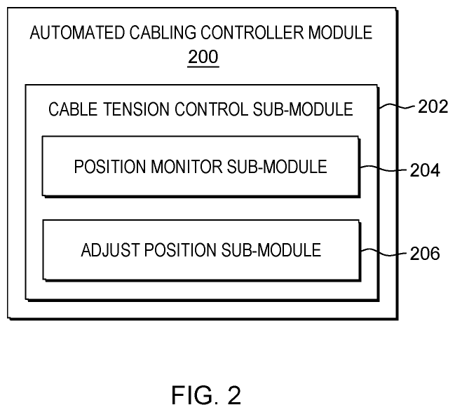

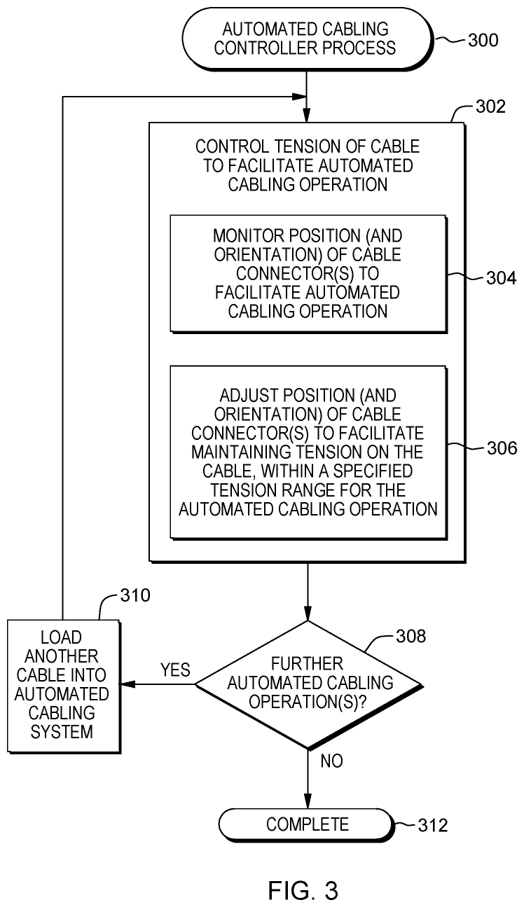

By way of example, one or more embodiments of an automated cabling controller module and process for an automated cabling system are described initially with reference to FIGS. 2-3. FIG. 2 depicts one embodiment of automated cabling controller module 200 that includes code or instructions to perform controller processing for an automated cabling system, in accordance with one or more aspects of the present disclosure, and FIG. 3 depicts one embodiment of an automated cabling controller process for an automated cabling system, in accordance with one or more aspects of the present disclosure.

Referring to FIGS. 1-2, automated cabling controller module 200 includes, in one example, various sub-modules used to perform processing, in accordance with one or more aspects of the present disclosure. The sub-modules are, e.g., computer-readable program code (e.g., instructions) in computer-readable media (e.g., persistent storage (e.g., persistent storage 113, such as a disk) and/or a cache (e.g., cache 121), as examples). The computer-readable media can be part of a computer program product and can be executed by and/or using one or more computers, such as computer(s)101; one or more processor sets 110 (FIG. 1); processors, such as one or more processors of processor set 110; and/or processing circuitry, such as processing circuitry of processor set 110, etc.

As noted, FIG. 2 depicts one embodiment of automated cabling controller module 200 which, in one or more implementations, includes, or facilitates, automated cabling controller processing for an automated cabling system in accordance with one or more aspects of the present disclosure. In the embodiment of FIG. 2 example, sub-modules of automated cabling controller module 200 include a cable tension control sub-module 202 to facilitate controlling tension of a cable to facilitate an automated cabling operation of the automated cabling system. In one or more embodiments, the automated cabling operation can include an automated plugging or unplugging of a cable connector relative to a respective connector receptacle, such as a connector receptacle of a component of a system or (system network). In embodiments, cable tension control sub-module 202 includes a position monitor sub-module 204 to monitor position, including angular position, of the cable connectors held, for instance, by first and second electromechanical mechanisms of the automated cabling system. As described herein, in one or more implementations, the first and second electromechanical mechanisms can each be a carriage assembly that moves along a guide, or a robotic tool (or automation tool).

In embodiments, cable tension control sub-module 202 further includes, an adjust position sub-module 206 to adjust, based on the monitoring of the position, or position and orientation (or angular position), of the first and second cable connectors, one or more of the first and second electromechanical mechanisms to maintain tension on the cable within, for instance, a specified, acceptable tension range to facilitate the automated cabling operation. In embodiments, the specified range can be, for instance, a set percentage above and/or below a desired constant tension on the cable for the automated cabling operation. For instance, in one or more embodiments, the constant tension is prespecified so that the cable is stretched taut during the cabling operation to avoid undue bending of the cable.

Note that although various sub-modules are described herein, automated cabling controller processing, such as disclosed, can use, or include, additional, fewer, and/or different sub-modules. A particular sub-module can include additional code, including code of other sub-modules, or less code. Further, additional and/or fewer sub-modules can be used. Many variations are possible.

Advantageously, one or more aspects disclosed herein facilitate system networking, and more particularly, facilitate automated cabling of one or more components of a system (or system network). In operation, a tension in the cable is maintained within a specified acceptable tension range and position/orientation of the connectors are monitored to facilitate the automated cabling operation, such as to prevent the cable from being snagged or experiencing an undesired bending radius during the cabling operation. In one or more embodiments, the automated cabling operation can include a plugging (or unplugging) of a cable connector of the cable into (or from) a component of a system, and a routing the cable within the system. Providing the desired tension can include, in one or more embodiments, providing strain relief to the cable, and allowing the automation tool, or robotic tool, to pick or place the cable connector from different positions and orientations, as ascertained by the controller. The ability to provide cable strain relief, while monitoring position and orientation of the connectors is achieved by unique carriage assemblies that provide three degrees or movement, while ensuring the position and orientation of each cable connector is known using encoders associated with the carriage assemblies. In embodiments, a constant tension force on the cable is maintained between, for instance, first and second electromechanical mechanisms of the automated cabling system by comparing, in three dimensions, distances between the first and second cable connectors to a specified cable length. Note that with the automated cabling system and the automated cabling controller described herein, there is no spooling of the cable and cable connectors. In addition, in embodiments, collection of cable-related data for the cable is facilitated in the automated cabling system by moving a cable held between the first and second electromechanical mechanisms past an inspection device, such as an imaging device, barcode scanner, etc., to ascertain cable-related data that identifies or characterizes one or more aspects of the cable, and/or one or more aspects of the cable connectors. Further, in one or more embodiments, the automated cabling controller disclosed herein can use a control algorithm (e.g., negative feedback system) to manage the cable during the cabling operation, providing greater autonomy to the automated cabling system. For instance, automated cabling operations with a collaborative robotic tool ensures that the connectors are plugged with the appropriate plug forces and correct orientations, greatly reducing the possibility of damage to the connectors and ports that could otherwise occur with a manual plugging. Further, with automated cabling, cable placement errors are eliminated. Further, an automated cabling system and operation such as described herein provides valuable data/metric tracking and allows continuous cable support. These benefits also greatly reduce the complexity of the cabling operations and costs associated with damaged parts.

In embodiments, the automated cabling controller module is used, in accordance with one or more aspects of the present disclosure, to control cable tension and route, and facilitate a automated cabling operation process. FIG. 3 depicts one example of an automated cabling controller process 300, such as disclosed herein. The process is executed, in one or more embodiments, by a computer (e.g., computer 101 (FIG. 1)), and/or one or more processor sets, such as a processor or processing circuitry (e.g., of processor set 110 of FIG. 1). In one example, code or instructions implementing the process, are part of a module, such as automated cabling controller module 200 of FIGS. 1-2. In other examples, the code can be included in one or more other modules and/or one or more other sub-modules of one or more other modules. Various options are available.

As illustrated in FIG. 3, in one example, automated cabling controller process 300 executing on one or more computers (e.g., computer 101 of FIG. 1), one or more processor sets (e.g., processor set 110 of FIG. 1, such as a processor or processing circuitry of the processor set) controls tension of the cable to facilitate an automated cabling operation 302. For instance, in one or more embodiments, controlling tension includes maintaining the cable substantially taut between the cable connectors with a desired tension force that is determined or specified to be appropriate for the cable during the automated cabling operation. In this manner, the cable is maintained substantially taut without experiencing excessive strain on the cable. In embodiments, controlling tension on the cable for the automated cabling operation includes monitoring position, including angular position, of one or more cable connectors of the cable during, at least in part, the automated cabling operation 304. For instance, while the cable connectors are held by the first and second electromechanical mechanisms, the position and orientation of one or both cable connectors are monitored, and once a first cable connector has been plugged into the corresponding connector receptacle, the system continues monitoring position and orientation of the second cable connector, including, for instance, until the second cable connector is plugged by the robotic tool into a corresponding connector receptacle of a same component or different component of the system network. In embodiments, controlling tension on the cable includes adjusting position and orientation of one or both cable connectors of the cable to facilitate maintaining a desired tension on the cable during, at least in part, the automated cabling operation. For instance, in one or more embodiments, the first and/or second electromechanical mechanism can be dynamically controlled by the controller to, for instance, maintain a desired tension on the cable within a specified range to maintain the cable substantially taut without undue strain during as much of the automated cabling operation as possible.

In one or more embodiments, based on the automated cabling operation being complete, for instance, based on the first and second cable connectors of the cable having been operatively coupled to (or removed from) the appropriate connector receptacles, the automated cabling controller process 300 determines whether there are further automated cabling operations to be performed 308. If “yes”, then another cable is loaded into the automated cabling system 310 and the controller proceeds to control tension of the other cable during its automated cabling operation. Once all automated cabling operations have been completed, the controller process is complete 312.

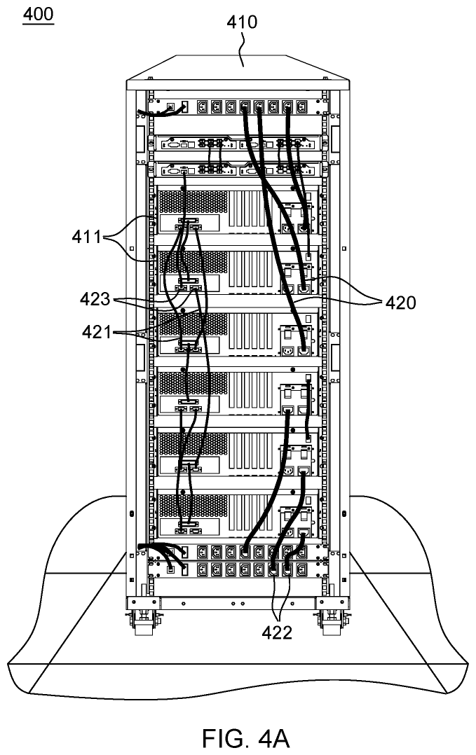

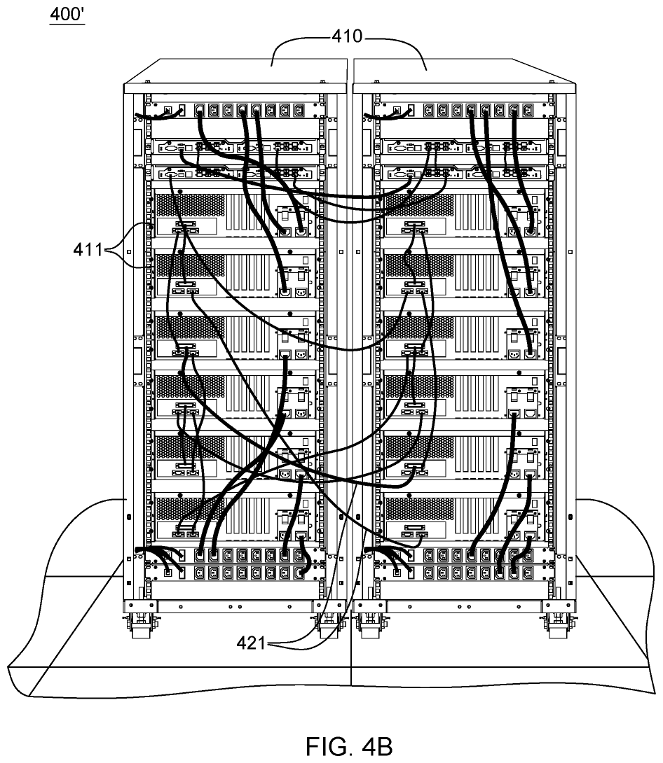

By way of example, FIG. 4A depicts one embodiment of a system network 400 including a rack 410 of computing equipment, which can represent a partial network, a single network, or multiple interconnected networks. Note also that the phrase “network” is used broadly herein to refer to any computer, communications, power, etc., system, with two or more components interconnected, such as by cables. The components can be any of a variety of components, with a rack, such as a server rack of a data center, being one example only of a network, or portion of a network, having cables plugged between components for a desired setup configuration. The cables can be, for instance, signal cables, power cables, input/output cables, or other communication or data cables, etc. In the example of FIG. 4A, multiple power cables 420 are shown, along with multiple signal or data cables 421 interconnecting multiple components 411, such as servers, of the system. Typically, a cable can have a cable connector at a first end, and another cable connector at a second end. Further, the components of the network are shown to have connector receptacles 422, 423 configured for operatively plugging or docking appropriate cable connectors into to interconnect components of the system in a desired network configuration. Note also that, although typically having a first end and a second end, a “cable” can include a configuration with multiple first ends and/or multiple second ends, each having associated therewith a cable connector to be plugged in the system to a respective connector receptacle.

Note that “cable connector” and “connector receptacle” are broadly used herein to refer to any first connector and any second connector configured to operatively plug together or dock so as to form an electrical or optical connection, such as to transfer signals, data, power, etc. The cable connector (or connector) can denote any type of connector that plugs or operatively docks into another connector, referred to as a connector receptacle (or receptacle).

FIG. 4B is a similar system network 400′ to system network 400 of FIG. 4A, with an exception being that multiple racks 410 of computing equipment are illustrated, by way of example. In this embodiment, multiple cables 421 operatively interconnect components in different racks of the network in a desired network configuration.

Note that the computer rack embodiments of FIGS. 4A-4B are depicted by way of example only of a type of system or system network within which cables and cable connectors can be used to operatively interconnect components of the system. The cable connector position and orientation monitoring and adjustment facilities disclosed herein can be applied to any type of cable or connector, and any type of system or network. For instance, monitoring position and orientation of cable connectors can be applied to power connectors, data connectors, signal connectors, communication connectors, or other types of cable connectors, etc.

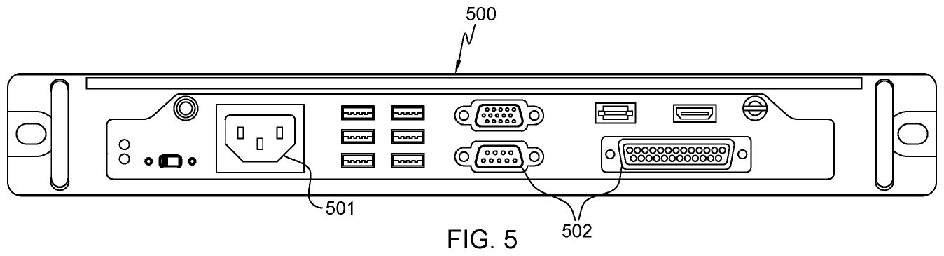

By way of further example, FIG. 5 depicts one embodiment of an electronic component having multiple different types of connector receptacles, including a power connector receptacle 501, as well as other data or signal connector receptacles 502. In one or more instances, a properly configured cable connector of a cable is to be plugged into the connector receptacle as desired for a particular system or system network configuration.

Existing solutions for cabling typically manage the cables and cable connectors in bundles, which often are not suitable for modern robotic tools (or automation tools). For instance, in order to facilitate automated cabling such as described herein, both ends of the cable (that is, both cable connectors in a two-connector embodiment) ideally have known positions and orientations relative to the robotic tool. In addition, it is desirable that location of the cable and cable connectors be monitored, so that the cable can be controlled to avoid becoming caught, tangled, damaged, or over bent, which can be problematic depending on the type of cable. Further, it is desirable that there be no undue strain on the cable during the automated cabling operation. These constraints make automated cabling difficult for many types of collaborative robotics with a single gripper. Advantageously, disclosed herein are automated cabling systems that help present and manage the cable, and in particular, the cable connectors, for handling by the robotic tool of the automated cabling system, or a robotic tool associated with the automated cabling system.

Depending on the system or system network, cabling can be a time consuming and difficult process. Various connector styles, connector lengths, plug forces, and system configurations add to the difficulty of cabling a system (or system network). Even with proper instructions and training, manual cabling can prove to be difficult due to limited space, and potentially breakable components, that are expensive and prone to damage. As a result of these complexities, disclosed herein are automated cabling systems and processes to facilitate, for instance, a robotic tool plugging and/or unplugging of cable connectors, and routing of cables within a system.

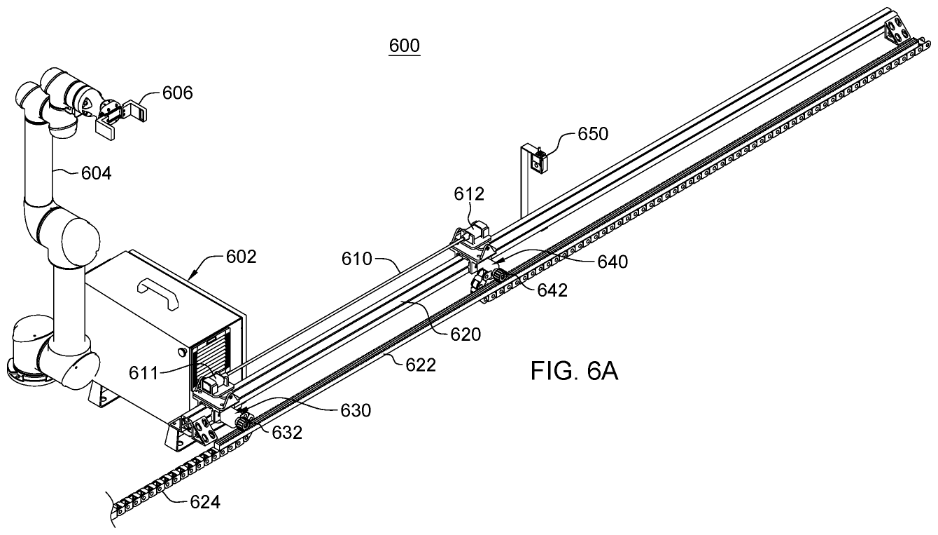

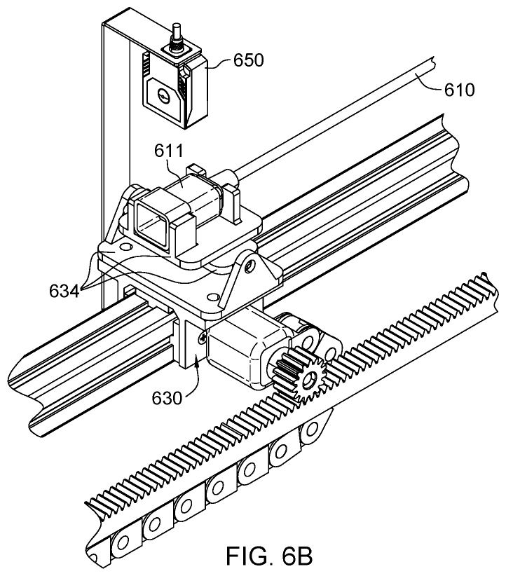

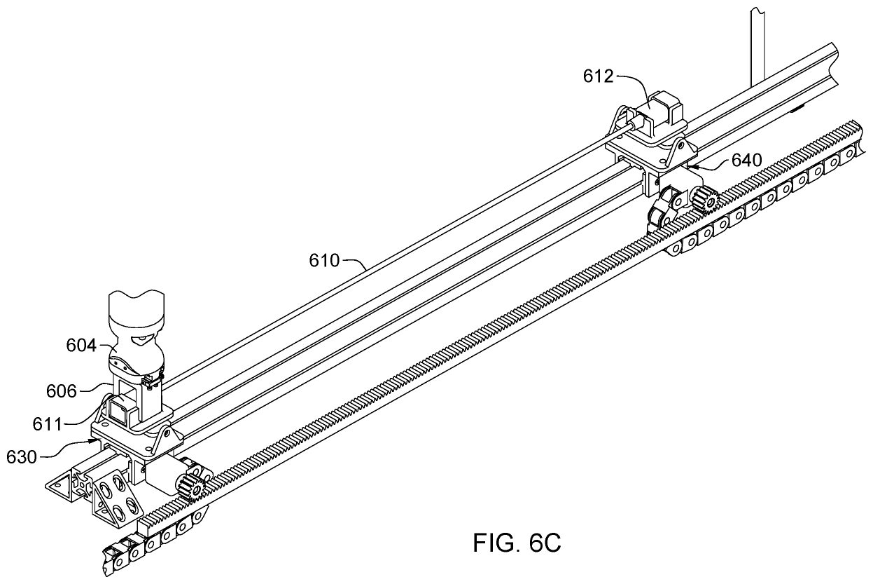

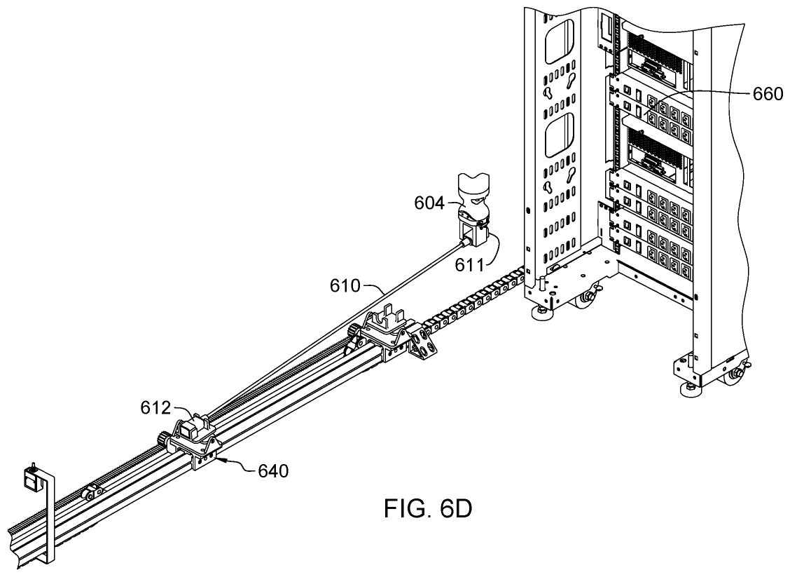

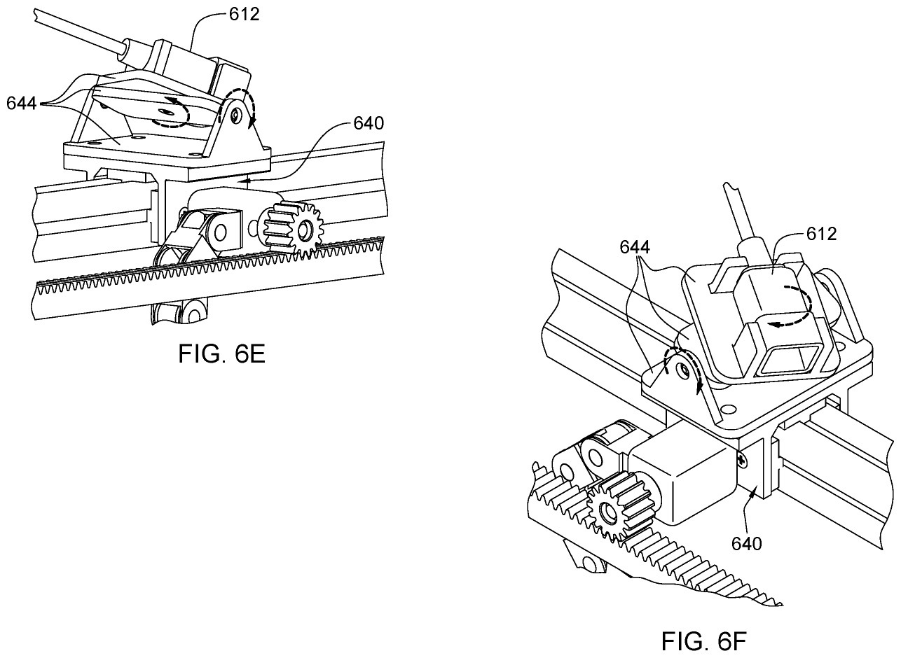

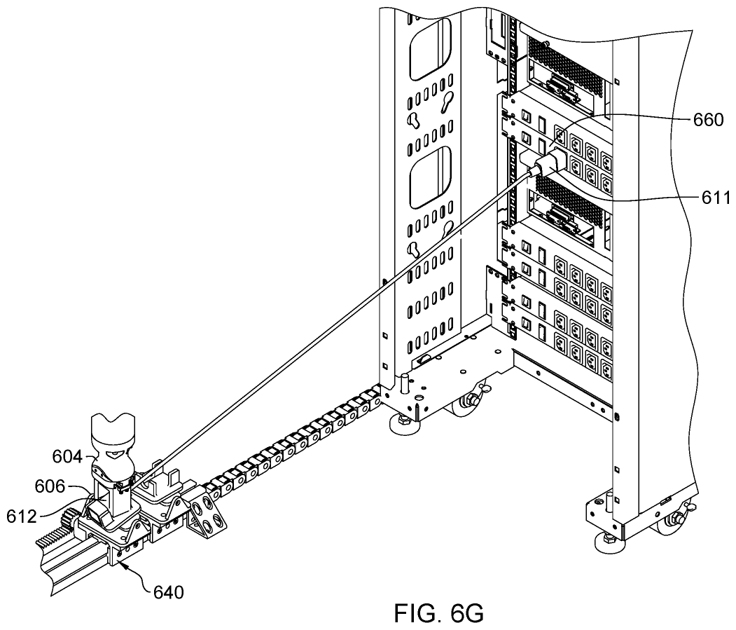

FIGS. 6A-6G depict one embodiment of an automated cabling system 600, in accordance with one or more aspects of the present disclosure. Referring collectively to FIGS. 6A-6G, automated cabling system 600 includes, in one or more embodiments, a cabling controller 602, including an automated cabling controller module 200 executing on a computer, such as described above in connection with FIGS. 1-3, and a robotic tool 604 with a gripper 606 for gripping, moving and plugging or unplugging cable connectors to facilitate automated cabling operations for a system (or system network), such as described herein.

Referring collectively to FIGS. 6A-6G, a first carriage assembly 630 and a second carriage assembly 640 are mounted on a guide, such as a linear guide or rail, and are operatively coupled to automated cabling controller 602, which controllably, independently moves the assemblies relative to each other. Each carriage assembly 630, 640 has a carriage mounted to guide 620 and an electrical motor that drives a pin 632, 642, respectively, on a rack, such as a linear rack 622, and associated cable management track 624 allowing the carriage (or carriage assembly) to controllably move along the guide 620. In embodiments, an encoder is associated with each motor and/or pin 632, 642 to track the position of the carriage along the guide, and thus the position of the respective cable connector 611, 612 of a cable 610 positioned for an automated cabling operation, such as described herein.

A rotatable fixture 634, 644, or rotatable connector fixture, is associated with a respective carriage assembly 630, 640. Each rotatable fixture 634, 644 is mounted to the respective carriage, and includes, in one or more embodiments, multiple plates. In one embodiment, a lower plate of the rotatable fixture holds the fixture to the respective carriage, and has two ball bearings, and an angular encoder that allows a middle plate to swivel about the lower plate (x-axis). The middle plate also has a ball bearing and an angular encoder associated with it that allows the upper plate to swivel about a perpendicular plane extending from the middle plate (z-axis). This assembly thus gives each cable connector three degrees of freedom, that is, the ability to move linearly along the guide (y-axis), as well as angular movement in two perpendicular planes on the respective carriage (x-axis, z-axis). The upper plate is configured to also serve to securely hold the cable connector until removed during the automated cabling operation. The encoders are operatively coupled to automated cabling controller 602 to provide positional data, including angular position data, on the cable connectors, which the controller uses to maintain the cable under tension within a specified range. In one or more embodiments, the tension range is a range of tension which provides sufficient tension to relieve bending strain, and prevent the cable from bending and being snagged during the automated cabling operation. In use, the automated cabling system, and in particular, the automated cabling controller 602, operates to maintain one cable connector of the cable in a known, safe position and/or orientation, while the robotic tool (or collaborative robot or cobot) is plugging or unplugging the opposite cable connector relative to a selected system component 660, and for managing the cable itself, for instance, to prevent the cable from being caught during the plugging or unplugging process.

In one or more embodiments, the automated cabling operation of the automated cabling system, includes a loading of a cable with cable connectors into the respective rotatable fixtures of the carriage assemblies. Note that in one or more embodiments, the loading can be performed manually, or itself can be an automated process, for instance, using an automated cable loading system (not shown). The controller 602 moves the carriage assemblies 630, 640 away from one another in order to create the desired tension within the cable, and in one or more embodiments, moves the carriage assemblies in tandem towards the robotic arm 604, passing under an optional inspection device 650 to scan the cable and/or cable connectors to obtain relevant cable-related data, such as type of cable, length of cable, type of cable connectors, etc. The inspection device can be any type of known wireless inspection instrument, such as a barcode scanner, RFID reader, imaging instrument, etc. to ascertain cable-related data for the cable held by the automated cabling system. The controller discontinues moving the carriage assemblies once the first (or forward) carriage assembly is within reach of the robotic tool. The controller initiates the robotic tool to pick up or grip the first cable connector from the first carriage assembly, with the location of the first cable connector being known to the controller from the different encoders associated with the first carriage assembly, such as described. As the robotic tool is plugging the first cable connector into the programmed component of the system, the second cable connector is allowed to swivel in two degrees of rotation, that is, in the two planes of the rotatable fixture, to relieve stress on the cable and allow the cable to remain taut. The second carriage is also moved by the controller along the guide to keep the cable in the acceptable tension range, that is, while the first cable connector is gripped and moved by the robotic tool. After the first cable connector has been plugged into the appropriate connector receptacle of the programmed system component, the controller moves the second cable connector within reach of the robotic tool, if not already within reach of the robotic tool, so that the robotic tool can grip and move the second cable connector to plug the second cable connector into its specified connector receptacle, for instance, as programed for a particular system network configuration. Note that the above described automated cabling operation can also be reversed for automated removal of cables from a system.

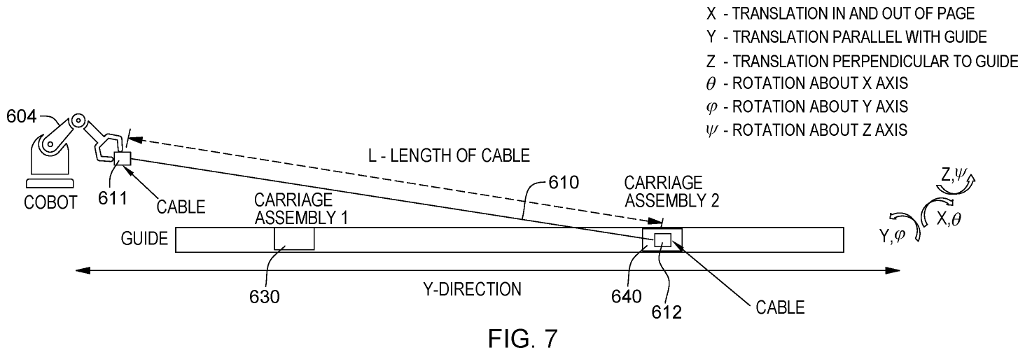

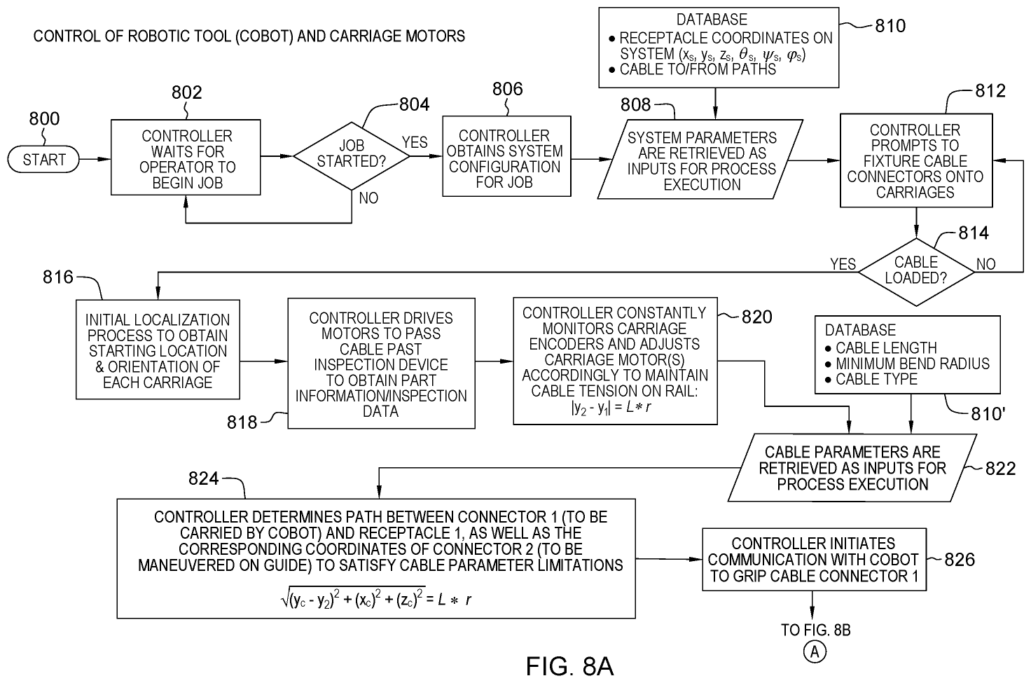

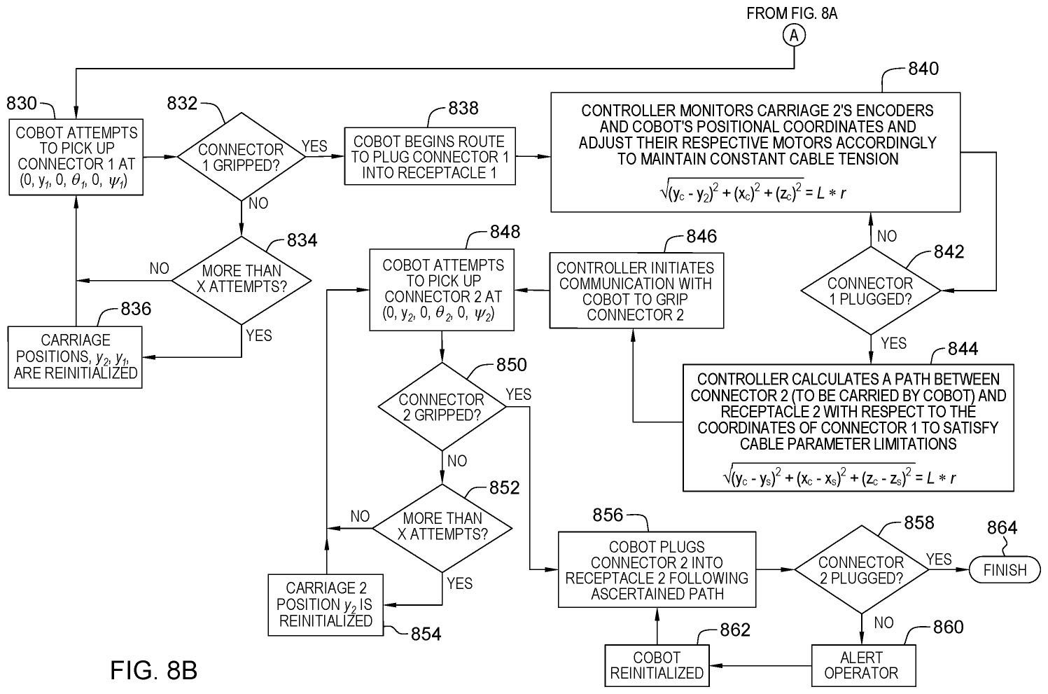

By way of further explanation, FIG. 7 depicts a schematic illustrating operation of an automated cabling system, such as automated cabling system 600 of FIGS. 6A-6G, in accordance with one or aspects of present disclosure. In accordance with one or more aspects, the automated cabling system, through the carriage assembly encoders and/or robotic tool, monitors position and orientation of the cable connectors 611, 612 of cable 610 in three dimensions to, for instance, facilitate robotic tool 604 gripping and moving cable 610 into a desired connection with the appropriate connector receptacles for a particular programmed configuration of the system. As discussed, first carriage assembly 630 and second carriage assembly 640 move along a guide with the carriage assembly positions being known relative to the guide, as well as the orientation of the respective cable connectors held during the cabling operation. In this manner, the connector position in XYZ dimensions, and orientation, θ, φ and ψ about the respective axis, are known. To facilitate a description of the automated cabling controller workflows of FIGS. 8A-9B, the following cable variables, cobot variables, and connector receptacle system variables are defined:

### Cable Variables:

### Connector 1 Coordinates:

x₁=0
y₁=position along guide
z₁=0
θ₁=theta angle of connector 1
φ₁=0
ψ₁=psi angle of connector 1

### Connector 2 Coordinates:

x₂=0
y₂=position along guide
z₂=0
θ₂=theta angle of connector 2
φ₂=0
ψ₂=psi angle of connector 2

### Cable:

L=length of cable
r=cable relief multiplier

### Cobot Variables:

### Coordinates:

x_{c}=cobot x-position
y_{c}=cobot y-position
z_{c}=cobot z-position
θ_{c}=cobot theta angle
φ_{c}=cobot phi angle
ψ_{c}=cobot psi angle

### Receptacle Variables:

### Coordinates:

xₛ=receptacle x-position
yₛ=receptacle y-position
zₛ=receptacle z-position
θₛ=receptacle theta angle
φₛ=receptacle phi angle
ψₛ=receptacle psi angle

FIGS. 8A-8B depict one embodiment of an automated cabling controller workflow for controlling, for instance, the robotic tool (e.g. cobot) and one or more carriage assembly motors, such as described above in connection with FIGS. 6A-6G. In this embodiment, the controller both reads and writes positional data to, for instance, the robotic tool (or cobot) and the carriage motors. Thus, in this embodiment, the controller controls and instructs the movement of the robotic tool, in addition to the carriages.

Referring to FIG. 8A, the automated cabling controller workflow starts 800 with the controller waiting, in one embodiment, for an operator to begin a job in the automated cabling system 802. Processing waits until a job is started 804, and once started obtains a system configuration for the job 806. In addition, the controller ascertains system parameters from, for instance, a database 810 (or memory) as inputs for the process execution 808. In embodiments, the system parameters can include, for instance, receptacle coordinates on the system, as well as, for instance, prespecified cable to/from paths, which can be stored as preconfigured paths based on the desired configuration of the system or system network. In embodiments, the controller prompts, for instance, an operator, to fixture the cable connectors onto the carriages or carriage assemblies 812 and waits until the cable is loaded 814. Once the cable is loaded, an initial localization process is initiated to obtain starting location and orientation of each carriage assembly 816.

In one or more embodiments, the controller drives the carriage motors to pass the cable through, or under, an inspection device 818, such as a barcode scanner such as camera, etc., to obtain cable-related data, such as cable part information, connector part information, cable inspection data, etc. In embodiments, the controller constantly monitors the carriage encoders and adjusts one or more carriage motors accordingly to maintain the desired constant cable tension 820. In one or more embodiments, the cable tension can be determined as noted in equation (1):

$$\vert {y}_{2} - {y}_{1} \vert = L * r \qquad ( 1 )$$

The cable parameters can be retrieved from storage 810′ as inputs for the cabling process execution 822. In one or more embodiments, a database 810′ (or memory) is operatively coupled to the controller from which the relevant cable parameters are retrieved, such as cable length, minimum bend radius, cable type, etc.

The controller determines or calculates a path between cable connector 1 (to be carried by the robotic tool (or cobot)) and a connector receptacle 1 of the system component to which the connector is to be operatively coupled, as well as the corresponding coordinates of connector 2 (to be maneuvered on the guide) to satisfy the cable parameter limitations. For instance, equation (2) sets out one embodiment of the calculation 824:

$$\sqrt{{( {y}_{c} - {y}_{2} )}^{2} + {( {x}_{c} )}^{2} + {( {z}_{c} )}^{2}} = L * r \qquad ( 2 )$$

The controller then initiates communication with the robotic tool (or cobot) to grip cable connector 1 826.

As illustrated in FIG. 8B, the robotic tool (or cobot) attempts to pick up connector 1 at 0, y₁, 0, θ₁, 0, ψ₁ 830. The controller determines whether connector 1 has been gripped by the robotic tool 832. If “no”, then the controller determines whether more than x attempts (e.g. two or more attempts) have been made 834. If “no”, then the process continues until x or more unsuccessful attempts have been made, at which time the controller reinitializes the carriage positions 836 and repeats the process. Once connector 1 is gripped by the robotic tool, the robotic tool (or cobot) begins to move the connector along the determined route or path to plug connector 1 into the corresponding receptacle 1 of the system component for the desired system configuration 838.

In embodiments, the controller constantly monitors carriage 2's encoders and the robotic tool's positional coordinates, and adjusts the respective motors accordingly to maintain the desired, constant cable tension 840. In one embodiment, the desired constant cable tension is determined as noted above with respect to equation (2). The controller determines whether connector 1 is plugged 842, and once plugged the controller determines a path between connector 2 (to be carried by the robotic tool) and the corresponding receptacle connector 2 with respect to the coordinates of connector 1 to satisfy the cable parameter limitations, including, for instance, equation (3) below.

$$\sqrt{{( {y}_{c} - {y}_{s} )}^{2} + {( {x}_{c} - {x}_{s} )}^{2} + {( {z}_{c} - {z}_{s} )}^{2}} = L * r \qquad ( 3 )$$

In one or more embodiments, the controller initiates communication with the robotic tool to grip connector 2 846 and the robotic tool (or cobot) attempts to pick up connector 2 at the ascertained location 0, y₂, 0, θ₂, 0, ψ₂ 848. The controller determines whether connector 2 has been gripped by the robotic tool 850, and if “no”, then the controller determines whether x attempts (e.g., two or more attempts) have been made 852. If “yes”, then the carriage 2 position y₂ is reinitialized 854. Once connector 2 is gripped by the robotic tool, the robotic tool (or cobot) connects connector 2 into the designated receptacle 2 following the ascertained path, which as noted, can be predetermined 856. The controller determines, in one or more embodiments, whether connector 2 is plugged in 858, and if “no”, alerts an operator 860 and reinitializes the robotic tool (or cobot) 862 to attempt re-plugging of the connector 2 into receptacle 2. Once connector 2 is plugged in, the workflow for the particular automated cabling operation is finished 864.

As noted, FIGS. 9A-9B depict another embodiment of an automated cabling system controller workflow 900, in accordance with one or more aspects of the present disclosure. The workflow of FIGS. 9A-9B depicts a controller process for controlling the carriage motors of the automated cabling system. In this embodiment, the controller reads positional data from the robotic tool and the carriage motors, but only writes positional data to the carriage motors. This embodiment is one embodiment of a reactive control system, where the carriages react to the movement of the robotic tool without knowing its movements ahead of time.

Referring to FIG. 9A, in one embodiment, automated cabling system controller workflow 900 starts with the controller waiting for an operator to initiate a cabling job 902. Once a cabling job is started 904, the controller obtains system configuration data for the job 906. System parameters are obtained from, for instance, a database 910 (or memory) as inputs for the process execution 908. In one or more embodiments, the system parameters can include identification of receptacle 1 and receptacle 2 coordinates on a system component (xₛ, yₛ, zₛ, θₛ, ψₛ, φₛ), as well as cable to/from paths. The controller prompts to fixture the cable with the cable connectors on the carriages or carriage assemblies 912. The controller waits until the cable is loaded 914, and once loaded, initializes a localization process to obtain the starting location and orientation of each carriage assembly, and thus, of each cable connector 916. In one or more embodiments, the controller constantly monitors the carriage encoders and adjusts each carriage motor accordingly to maintain the desired cable tension using, for instance, equation (1) above. In one or more embodiments, the controller drives the carriage motors to pass the cable through or under the inspection device, such as a barcode scanner, camera, imaging device, etc., to obtain cable-related data 920. In one or more embodiments, cable parameters are obtained from storage as inputs for the process execution 922. For instance, the controller includes, or is operatively coupled to, a database 910′ (or memory), which includes cable parameters for the process, such as cable length, minimum cable bend radius, connector type, etc. In one or more embodiments, the controller initiates communication with the robotic tool (or cobot) to grip connector 1 924.

As illustrated in FIG. 9B, the robotic tool attempts to pick up connector 1 at 0, y₁, 0, θ₁, 0, ψ₁ 926. The controller determines whether connector 1 has been gripped by the robotic tool 928. If “no”, then the controller determines whether more than x attempts (e.g., two or more attempts) have been made 930. If “no”, then the process continues until more than x unsuccessful attempts have been made, at which time the controller reinitializes the carriage positions y₂, y₁ 932, and repeats the process. Once connector 1 is gripped, the controller monitors carriage 2's encoders and the robotic tool's positional coordinates, and adjusts the respective motors accordingly to maintain a constant cable tension (i.e., a cable tension within a specified tension range). For instance, equation (4) below can be used by the controller in maintaining the constant cable tension:

$$\sqrt{{( {y}_{c} - {y}_{2} )}^{2} + {( {x}_{c} )}^{2} + {( {z}_{c} )}^{2}} = L * r \qquad ( 4 )$$

In one or more embodiments, the robotic tool attempts to plug connector 1 into the specified receptacle 1 936, and determines whether connector 1 has been properly plugged into receptacle 1 938 and if “no”, then an operator is alerted 940.

Assuming that the robotic tool has properly plugged or docked connector 1 into receptacle 1, then the controller initiates communication with the robotic tool to grip connector 2 942. The robotic tool (or cobot) attempts to pick up connector 2 at 0, y₂, 0, θ₂, 0, ψ₂ 944. In one or more embodiments, the controller determines whether connector 2 has been gripped by robotic tool 946 and if “no”, then determines whether more than x attempts have been made 948, where x is a programmable number of attempts. If “no”, then the robotic tools continues to attempt to pick up connector 2 944 until, possibly, more than x attempts have been made 948, in which case the controller reinitializes carriage 2 position y₂ 950.

Once connector 2 has been gripped by the robotic tool, the robotic tool is controlled to plug connector 2 into its specified receptacle 2 following the ascertained path 952. The controller determines whether connector 2 has been properly plugged or docked into receptacle 2 954, and if “no”, then the operator is alerted 940. Otherwise, the automated cabling operation for the particular cable is complete 956.

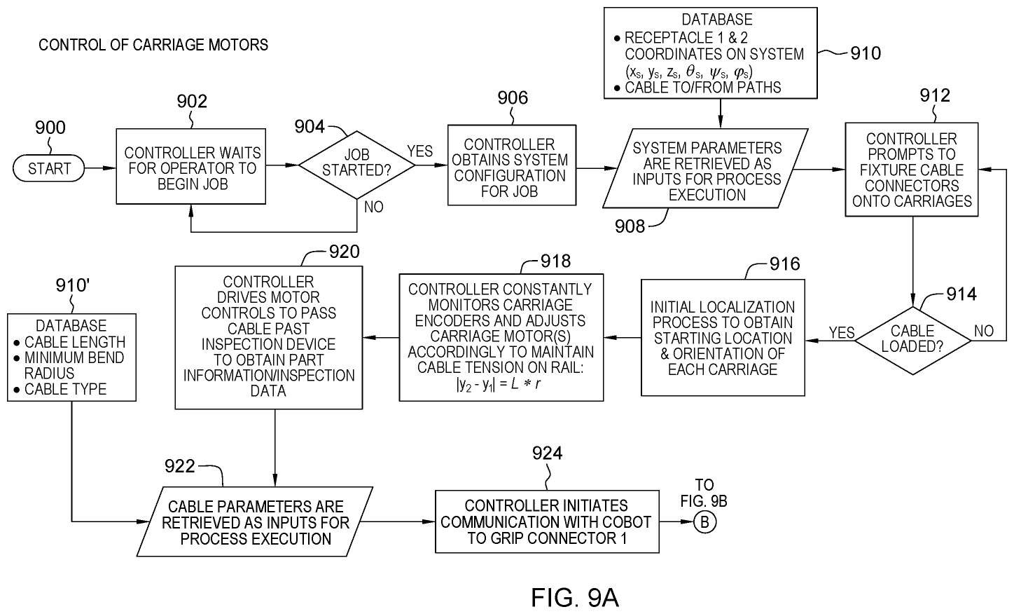

By way of further example, FIG. 10 is a partial depiction of an alternate embodiment of an automated cabling system denoted 600′, which is similar to automated cabling system 600 of FIGS. 6A-6G. A principal difference with automated cabling system 600′ from automated cabling system 600 of FIGS. 6A-6G is that one electric motor 1000 is illustrated in the embodiment of FIG. 10 to drive a threaded rod (e.g. threaded guide) that replaces the guide (e.g. linear rail) of the embodiment of FIGS. 6A-6G, and potentially moves the carriage assemblies 630′, 640′ in tandem (in the case of a fully threaded rod). For instance, in one or more embodiments, the respective carriage assemblies 630′, 640′ can each include a nut that causes the carriage assembly to move along the threaded rod as the threaded rod is spun by the motor.

In one or more other embodiments, a threaded rod 1010 can include one or more unthreaded sections 1011 and one or more threaded sections 1012 as desired for the particular application. For instance, the automated cabling system 600′ can be configured to operate within certain constraints with known travel ranges predefined for the respective carriage assemblies 630′, 640′ such that only portions of the threaded rod in those ranges need to be threaded for that application. Note that this embodiment may require additional manual intervention to setup, but it would be less costly than, for instance, an automated cabling system such as depicted in FIGS. 6A-6G and described above. In a specific embodiment of FIG. 10, carriage assembly 630′ will not move initially until the cable is taut, after which carriage assembly 630′ is pulled onto the threaded portion of the rod by movement of the other carriage assembly 640′ and cable over threaded portion 1012 of threaded rod 1010. Note that many variations are possible, with the embodiment of FIG. 10 being one representative embodiment only.

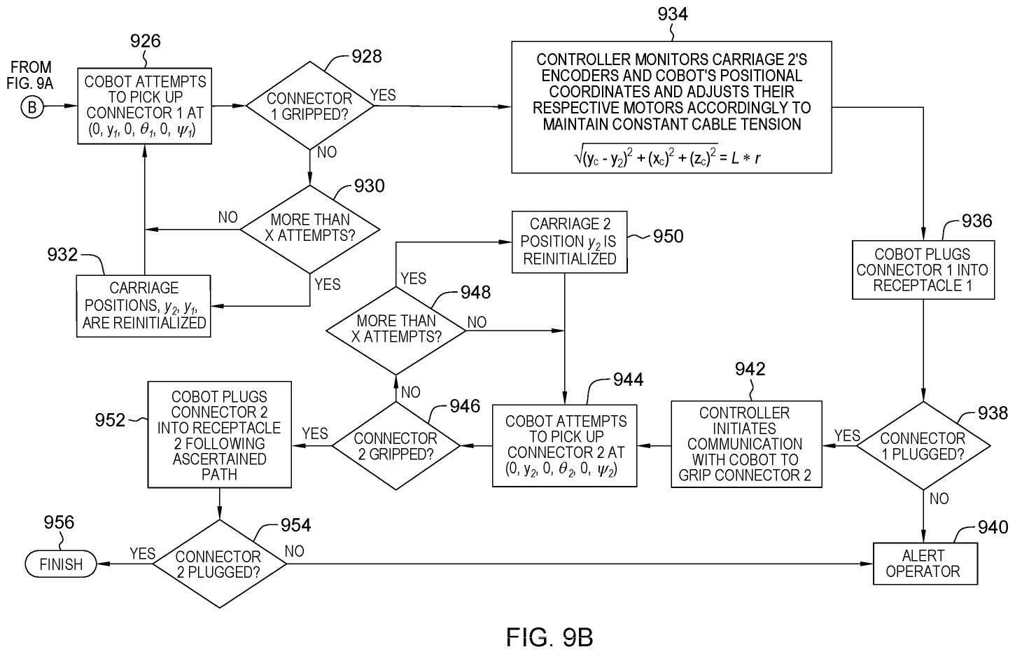

FIG. 11 is a schematic of a further embodiment of an automated cabling system, in accordance with one or more aspects disclosed herein. In this embodiment, a closed track or closed guide is used to allow, for instance, parallel loading of one cable at one set of carriage assemblies 1100 with performance of an automated cabling operation in an assembly area via another set of carriages 1101, where the one set of carriages 1100 and the other set of carriages 1101 move two different cables, potentially over longer distances, such as between a cable storage location (e.g., cable crypt) and an automated cabling station (e.g., system network assembly station), while the cable remains in tension on the associated carriage assemblies. Note that many different types of guides can be used in association with an automated cabling system such as disclosed herein, with the linear guide of FIGS. 6A-6G and the closed guide of FIG. 11 being two examples only.

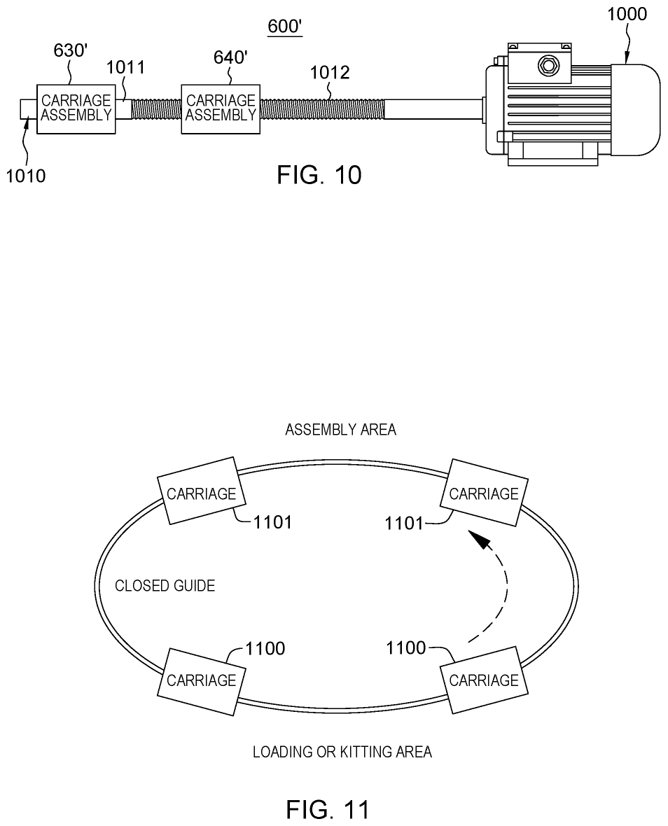

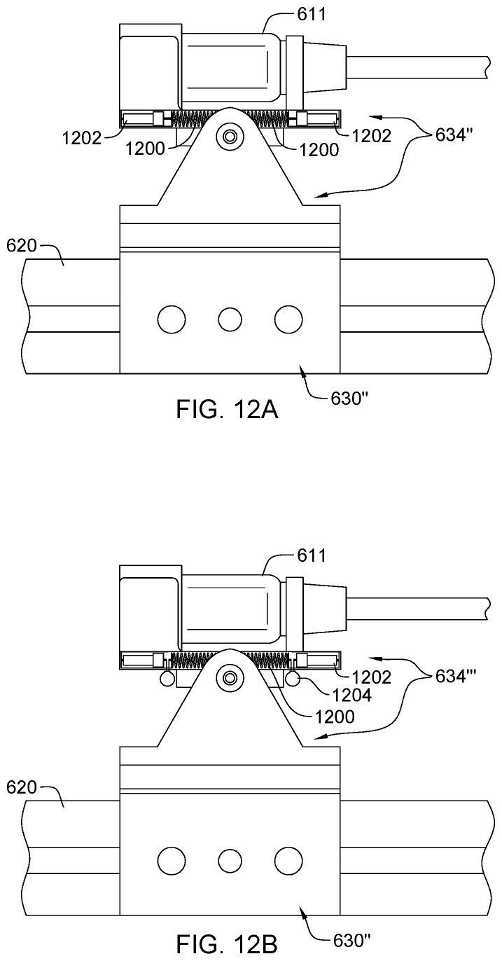

FIGS. 12A-12B depict alternate embodiments of a carriage assembly and rotatable fixture for an automated cabling system, such as disclosed herein. In these embodiments, the carriage assembly 630″ is similar to carriage assembly 630 described above in connection with FIGS. 6A-6G. Referring collectively to FIGS. 12A-12B, the carriage assembly 630″ moves along a guide 620, and holds a respective cable connector 611 on a rotatable fixture 634″, 634′″ with two degrees of rotation. In this embodiment, rather than using electric motors on the carriage assembly, compression springs 1200 (aligned, for instance, along the axis of the rail) are provided. The compression springs 1200 are configured and positioned to help the carriage assembly return to equilibrium state, and to partially resist any sudden forces applied to the connector. In this approach, rather than the controller using a control algorithm to compare distances between each connector of the cable to obtain a constant tension, four sensors 1204 (FIG. 12B) can be mounted along the axis of the rail for an alternate input to the controller's control algorithm. This embodiment would simplify the control system architecture. In the embodiments of FIGS. 12A-12B, in addition to lateral springs, lateral dampers 1202 can also be provided. The lateral springs and dampers can be added, in one or more embodiments, to the rotating fixture 634″, 634′″ of the respective carriage assembly to allow the carriage assembly to be “pulled” by the cable without excess acceleration or strain on the cable. In embodiments, springs 1200 operate to bring the upper plate of rotatable fixture 634″, 634′″ back into equilibrium when it is not subjected to a force, and the dampers 1202 resist the force to prevent the connector from oscillating or being subject to strain. The optional force sensors 1204 (FIG. 12B) can be included to relay the force on the upper plate of the rotatable fixture 634′″ (FIG. 12B), and to drive subsequent control actions, such as slowing down the leading carriage assembly or robotic arm.

Advantageously, disclosed herein are automated cabling systems, computer-implemented methods, and computer program products for facilitating automated cabling operations. In one or more embodiments, the automated cabling system includes a first carriage assembly to support a first cable connector of a cable, and a second carriage assembly to support a second cable connector of the cable, with the first and second carriage assemblies to move along a guide, such as a rail. The system further includes a controller to monitor and adjust position of at least the second carriage assembly to maintain tension on the cable within a specified range during an automated cabling operation of the system. For instance, the specified range can be a specified acceptable range about a desired constant tension on the cable.

In embodiments, the second carriage assembly includes a rotatable fixture to hold the second cable connector of the cable, with the rotatable fixture of the second carriage assembly including two degrees of rotation. In embodiments, the controller is configured to monitor position and orientation of the second cable connector supported by the second carriage assembly to facilitate adjusting position of at least the second carriage assembly to maintain the tension on the cable within the specified range during the automated cabling.

In embodiments, one or more encoders are associated with the second carriage assembly to ascertain angular position of the second cable connector supported by the second carriage assembly during the automated cabling operation, where the one or more encoders are operatively coupled to the controller.

In one or more embodiments, the first carriage includes a rotatable fixture to hold the first cable connector of the cable, with the rotatable fixture of the first carriage assembly including two degrees of rotation. The controller is further configured to monitor the position and orientation of the first cable connector supported by the first carriage assembly to facilitate adjusting position of the first carriage assembly to maintain tension on the cable within the specified range during the automated cabling operation.

In embodiments, one or more first encoders are associated with the first carriage assembly to ascertain angular position of the first cable connector supported by the first carriage assembly during the automated cabling operation, and one or more second encoders are associated with the second carriage assembly to ascertain angular position of the second cable connector supported by the second carriage assembly during the automated cabling operation, where the first and second encoders are operatively coupled to the controller.

In embodiments, the controller is operatively coupled to a robotic tool of the system to, in part, facilitate gripping and moving the first cable connector during the automated cabling operation. In one or more embodiments, the rotatable fixture of the second carriage assembly further includes a lateral spring and damper to allow the robotic tool to pull the cable and second carriage assembly during the automated cabling operation without excessive strain or acceleration on the cable.

In one or more embodiments, the guide is a linear guide and movement of the first and second carriage assemblies along the guide provide the first and second cable connectors with one degree of movement, and wherein the first carriage assembly and the second carriage assembly each include a respective rotatable fixture with two degrees of rotation when supporting the corresponding first or second connector during the automated cabling operation.

In one or more embodiments, the controller is operatively coupled to a robotic tool of the system to facilitate gripping and moving of at least one connector of the first and second cable connectors during the automated cabling operation. In one embodiment, the controller is configured to provide strain relief to the cable during the moving of the at least one connector by the robotic tool as part of the automated cabling operation.

In one or more embodiments, the automated cabling system further includes an inspection device operatively coupled to the controller, with the inspection device being positioned to scan, at least in part, the cable as the cable moves with the first and second carriages along the guide to obtain cable-related data for facilitating the automated cabling operation.

In another aspect, a computer-implemented method is provided with includes controlling, by a controller operatively coupled to a first electromechanical mechanism and a second electromechanical mechanism of an automated cabling system, tension on a cable held by the first electromechanical mechanism and the second electromechanical mechanism within a specified range during an automated cabling operation. The first electromechanical mechanism hold a first cable connector of the cable, and the second electromechanical mechanism hold a second cable connector of the cable. The controlling includes monitoring position and orientation of at least one cable connector of the first and second cable connectors held by the first and second electromechanical mechanisms respectively, during the automated cabling operation, and adjusting, based on the monitoring of the position and orientation of the at least one cable connector, one or more of the first electromechanical mechanism and second electromechanical mechanism to maintain tension on the cable within the specified range to facilitate the automated cabling operation of the automated cabling system.

In embodiments, the second electromechanical mechanism includes a second carriage assembly, where the second carriage assembly is operatively coupled to move along a guide, and where the adjusting, by the controller, includes adjusting position of the second carriage assembly along the guide to maintain the tension on the cable within the specified range to facilitate the automated cabling operation.

In one or more embodiments, the second carriage assembly includes a rotatable fixture to hold the second cable connector of the cable, where the rotatable fixture of the second carriage assembly includes two degrees of rotation. In this case, the monitoring by the controller includes ascertaining encoder data representative of angular position of the second cable connector held by the rotatable fixture of the carriage assembly during the automated cabling operation.

In one or more embodiments, the first electromechanical mechanism includes a first carriage assembly operatively coupled to move along the guide, and the controlling, by the controller, further includes moving the first and second carriage assemblies along the guide to facilitate scanning the cable by an inspection device to obtain cable-related data for the automated cabling operation.

In one or more embodiments, the first electromechanical mechanism includes a robotic tool, and the adjusting, by the controller, is to maintain the tension on the cable within a specified range as the robotic tool moves the first cable connector into operative connection with a connector receptacle of a system component. In one embodiment, the adjusting, by the controller, includes determining a path for the robotic tool, and coordinates of the robotic tool and the second carriage assembly, to facilitate maintaining the tension on the cable within the specified range as the robotic tool moves the first cable connector into operative connection with the connector receptacle of the system component.

In a further aspect, a computer program product is provided which includes a set of one or more computer-readable storage media, and program instructions, collectively stored in the set of one or more storage media, for causing at least one processor set to perform computer operations which include, for instance, the above/summarized computer-implemented methods.

In one or more other aspects, a system (or apparatus), and method are provided for managing cables using an automation or robotic tool. The method includes, in one or more embodiments, receiving a cable in a loading area of the robotic tool, with the cable being moveably attached at opposing ends (that is, at the cable connectors), to slidable carriage assemblies on a guide. Further, the method includes gripping, using the robotic tool, one of connectors based on position data received at a controller from one or more encoders or sensors attached to the carriage assemblies, with the position data, and optionally orientation data, identifying location of the connectors in three dimensions for the automated cabling system. In one or more embodiments, the controller is operatively coupled to the robotic tool. Further, the method includes attaching, using the robotic tool, one of the connectors to a respective connector receptacle of a system component as programed for a particular network configuration. During the moving and attaching process, the cable remains at a desired level of tension using the robotic tool and the movable carriage assemblies, and the cable is routed via a specified path.

The computing environments described herein are only examples of computing environments that can be used. One or more aspects of the present disclosure may be used with many types of environments. The computing environments provided herein are only examples. Each computing environment is capable of being configured to include one or more aspects of the present disclosure.

Other aspects, variations and/or embodiments are possible.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

Yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, other memory access instructions may be used. Further, other predictors may be used, including, but not limited to, other examples of a counter table and/or a global counter. Many variations are possible.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting of the disclosure. As used herein, the singular forms “a”, “and” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A system comprising:
a first carriage assembly to support a first cable connector of a cable;
a second carriage assembly to support a second cable connector of the cable, the first and second carriage assemblies to move along a guide; and
a controller to monitor and adjust position of at least the second carriage assembly to maintain tension on the cable within a specified range during an automated cabling operation of the system.

2. The system of claim 1, wherein the second carriage assembly comprises a rotatable fixture to hold the second cable connector of the cable, the rotatable fixture of the second carriage assembly including two degrees of rotation, and wherein the controller is configured to monitor position of the second cable connector supported by the second carriage assembly to facilitate adjusting position of at least the second carriage assembly to maintain the tension on the cable within the specified range during the automated cabling operation.

3. The system of claim 2, further comprising one or more encoders associated with the second carriage assembly to ascertain angular position of the second cable connector supported by the second carriage assembly during the automated cabling operation, the one or more encoders being operatively coupled to the controller.

4. The system of claim 2, wherein the first carriage assembly comprises a rotatable fixture to hold the first cable connector of the cable, the rotatable fixture of the first carriage assembly including two degrees of rotation, and wherein the controller is configured to monitor position of the first cable connector supported by the first carriage assembly to facilitate adjusting position of the first carriage assembly to maintain the tension on the cable within the specified range during the automated cabling operation.

5. The system of claim 4, further comprising one or more first encoders associated with the first carriage assembly to ascertain angular position of the first cable connector supported by the first carriage assembly during the automated cabling operation, and one or more second encoders associated with the second carriage assembly to ascertain angular position of the second cable connector supported by the second carriage assembly during the automated cabling operation, wherein the first and second encoders are operatively coupled to the controller.

6. The system of claim 2, wherein the controller is operatively coupled to a robotic tool of the system to, in part, facilitate gripping and moving the first cable connector during the automated cabling operation, and wherein the rotatable fixture of the second carriage assembly further comprises at least one lateral spring and damper to allow the robotic tool to pull the cable and second carriage assembly during the automated cabling operation without excessive strain or acceleration on the cable.

7. The system of claim 1, wherein the guide is a linear guide and movement of the first and second carriage assemblies along the guide provide the first and second cable connectors with one degree of movement, and wherein the first carriage assembly and the second carriage assembly each include a rotatable fixture with two degrees of rotation in supporting the first and second cable connectors, respectively, during the automated cabling operation.

8. The system of claim 1, wherein the controller is operatively coupled to a robotic tool of the system to facilitate gripping and moving of at least one connector of the first and second cable connectors during the automated cabling operation.

9. The system of claim 8, wherein the controller is configured to provide strain relief to the cable during the moving of the at least one connector by the robotic tool as part of the automated cabling operation.

10. The system of claim 1, wherein the system further comprises an inspection device operatively coupled to the controller, the inspection device being positioned to scan, at least in part, the cable as the cable moves with the first and second carriages along the guide to obtain cable-related data for facilitating the automated cabling operation.

11. A computer-implemented method comprising:
controlling, by a controller operatively coupled to a first electromechanical mechanism and a second electromechanical mechanism of an automated cabling system, tension on a cable held by the first electromechanical mechanism and the second electromechanical mechanism within a specified range during an automated cabling operation, the first electromechanical mechanism holding a first cable connector of the cable, and the second electromechanical mechanism holding a second cable connector of the cable, the controlling comprising:
monitoring position and orientation of at least one cable connector of the first and second cable connectors held by the first and second electromechanical mechanisms, respectively, during the automated cabling operation; and
adjusting, based on the monitoring of the position and orientation of the at least one cable connector, one or more of the first electromechanical mechanism and second electromechanical mechanism to maintain the tension on the cable within the specified range to facilitate the automated cabling operation of the automated cabling system.

12. The computer-implemented method of claim 11, wherein the second electromechanical mechanism comprises a second carriage assembly, the second carriage assembly being operatively coupled to move along a guide, and wherein the adjusting by the controller comprises adjusting a position of the second carriage assembly along the guide to maintain the tension on the cable within the specified range to facilitate the automated cabling operation.

13. The computer-implemented method of claim 12, wherein the second carriage assembly comprises a rotatable fixture to hold the second cable connector of the cable, and wherein the rotatable fixture of the second carriage assembly comprises two degrees of rotation, and the monitoring by the controller comprises ascertaining encoder data representative of angular position of the second cable connector held by the rotatable fixture of the second carriage assembly during the automated cabling operation.

14. The computer-implemented method of claim 12, wherein the first electromechanical mechanism comprises a first carriage assembly operatively coupled to move along the guide, and wherein the controlling, by the controller, further comprises moving the first and second carriage assemblies along the guide to facilitate scanning the cable by an inspection device to obtain cable-related data for the automated cabling operation.

15. The computer-implemented method of claim 12, wherein the first electromechanical mechanism comprises a robotic tool, and wherein the adjusting, by the controller, is to maintain the tension on the cable within the specified range as the robotic tool moves the first cable connector into operative connection with a connector receptacle of a system component.

16. The computer-implemented method of claim 15, wherein the adjusting, by the controller, includes determining a path for the robotic tool, and coordinates of the robotic tool and the second carriage assembly to facilitate maintaining the tension on the cable within the specified range as the robotic tool moves the first cable connector into operative connection with the connector receptacle of the system component.

17. A computer program product comprising:
a set of one or more computer-readable storage media; and
program instructions, collectively stored in the set of one or more storage media, for causing at least one processor set to perform computer operations comprising:
controlling, by a controller operatively coupled to a first electromechanical mechanism and a second electromechanical mechanism of an automated cabling system, tension on a cable held by the first electromechanical mechanism and the second electromechanical mechanism within a specified range during an automated cabling operation, the first electromechanical mechanism holding a first cable connector of the cable, and the second electromechanical mechanism holding a second cable connector of the cable, the controlling comprising:
monitoring position and orientation of at least one cable connector of the first and second cable connectors held by the first and second electromechanical mechanisms, respectively, during the automated cabling operation; and
adjusting, based on the monitoring of the position and orientation of the at least one cable connector, one or more of the first electromechanical mechanism and second electromechanical mechanism to maintain the tension on the cable within the specified range to facilitate the automated cabling operation of the automated cabling system.

18. The computer program product of claim 17, wherein the second electromechanical mechanism comprises a second carriage assembly, the second carriage assembly being operatively coupled to move along a guide, and wherein the adjusting by the controller comprises adjusting a position of the second carriage assembly along the guide to maintain the tension on the cable within the specified range to facilitate the automated cabling operation.

19. The computer program product of claim 18, wherein the second carriage assembly comprises a rotatable fixture to hold the second cable connector of the cable, and wherein the rotatable fixture of the second carriage assembly comprises two degrees of rotation, and the monitoring by the controller comprises ascertaining encoder data representative of angular position of the second cable connector held by the rotatable fixture of the second carriage assembly during the automated cabling operation.

20. The computer program product of claim 18, wherein the first electromechanical mechanism comprises a robotic tool, and wherein the adjusting, by the controller, is to maintain the tension on the cable within the specified range as the robotic tool moves the first cable connector into operative connection with a connector receptacle of a system component.
